(19) United States
(12) Patent Application Publication
(10) Pub. No.: US 2024/0007463 A1
(43) Pub. Date: Jan. 4, 2024

(54) AUTHENTICATING COMMANDS ISSUED THROUGH A CLOUD PLATFORM TO EXECUTE CHANGES TO INVENTORY OF VIRTUAL OBJECTS DEPLOYED IN A SOFTWARE-DEFINED DATA CENTER

(71) Applicant: VMware, Inc., Palo Alto, CA (US)

(72) Inventors: Andrew GORMLEY, Bothell, WA (US); Durgaprasad KARRI, Cupertino, CA (US); Mathangi VENKATESAN, Cupertino, CA (US); Sandip P. THUBE, Palo Alto, CA (US); Maitreyee SAIKIA, Union City, CA (US); John E. BREZAK, Camano Island, WA (US); Narasimha MURTHI, Bangalore (IN)

(21) Appl. No.: 17/855,317

(22) Filed: Jun. 30, 2022

(51) Int. Cl. H04L 9/40

(52) U.S. Cl. CPC H04L 63/0853; H04L 63/105

(57) ABSTRACT

Commands that are input through a cloud platform are delivered to a management appliance of a software-defined data center (SDDC). A number of tokens are issued in the process of delivering the commands from the cloud platform to the management appliance. A method of issuing a command to the management appliance to modify an inventory of virtual objects deployed in the SDDC, includes: retrieving a message generated by a cloud service, the message including a task to modify the inventory of virtual objects deployed in the SDDC, a first token identifying a user who requested the task, and a second token containing information about the management appliance and a role assigned to the user; exchanging the first and second tokens with the management appliance for an authentication token for accessing the management appliance; and transmitting the command to the management appliance along with the authentication token.

### BACKGROUND

In a software-defined data center (SDDC), virtual infrastructure, which includes virtual machines (VMs) and virtualized storage and networking resources, is provisioned from hardware infrastructure that includes a plurality of host computers (hereinafter also referred to simply as “hosts”), storage devices, and networking devices. The provisioning of the virtual infrastructure is carried out by SDDC management software that is deployed on management appliances, such as a VMware vCenter Server® appliance and a VMware NSX® appliance, from VMware, Inc. The SDDC management software communicates with virtualization software (e.g., a hypervisor) installed in the hosts to manage the virtual infrastructure.

It has become common for multiple SDDCs to be deployed across multiple clusters of hosts. Each cluster is a group of hosts that are managed together by the management software to provide cluster-level functions, such as load balancing across the cluster through VM migration between the hosts, distributed power management, dynamic VM placement according to affinity and anti-affinity rules, and high availability (HA). The management software also manages a shared storage device to provision storage resources for the cluster from the shared storage device, and a software-defined network through which the VMs communicate with each other. For some customers, their SDDCs are deployed across different geographical regions, and may even be deployed in a hybrid manner, e.g., on-premise, in a public cloud, and/or as a service. “SDDCs deployed on-premise” means that the SDDCs are provisioned in a private data center that is controlled by a particular organization. “SDDCs deployed in a public cloud” means that SDDCs of a particular organization are provisioned in a public data center along with SDDCs of other organizations. “SDDCs deployed as a service” means that the SDDCs are provided to the organization as a service on a subscription basis. As a result, the organization does not have to carry out management operations on the SDDC, such as configuration, upgrading, and patching, and the availability of the SDDCs is provided according to the service level agreement of the subscription.

With a large number of SDDCs, monitoring and performing operations on the SDDCs through interfaces, e.g., application programming interfaces (APIs), provided by the management software, and managing the lifecycle of the management software, have proven to be challenging. Conventional techniques for managing the SDDCs and the management software of the SDDCs are not practicable when there is a large number of SDDCs, especially when they are spread out across multiple geographical locations and in a hybrid manner.

### SUMMARY

One or more embodiments provide a cloud platform from which various services, referred to herein as “cloud services” are delivered to the SDDCs through agents of the cloud services that are running in an appliance (referred to herein as a “agent platform appliance”). As used herein, an SDDC is a virtual computing environment provisioned from a plurality of host computers, storage devices, and networking devices by management software for the virtual computing environment that communicates with hypervisors running in the host computers. The cloud platform is a computing platform that hosts containers or virtual machines corresponding to the cloud services that are delivered from the cloud platform. The agent platform appliance is deployed in the same customer environment, e.g., a private data center, as the management appliances of the SDDCs. In one embodiment, the cloud platform is provisioned in a public cloud and the agent platform appliance is provisioned as a virtual machine, and the two are connected over a public network, such as the Internet. In addition, the agent platform appliance and the management appliances are connected to each other over a private physical network, e.g., a local area network. Examples of cloud services that are delivered include an SDDC configuration service, an SDDC upgrade service, an SDDC monitoring service, an SDDC inventory service, a message broker service, and a service for modifying the inventory of virtual objects deployed in the SDDC (hereinafter referred to as the “mutation service”). As used herein, virtual objects are virtualized resources (e.g., virtual machines and virtual disks) that have been provisioned in the SDDC. Each of these cloud services has a corresponding agent deployed on the agent platform appliance. All communication between the cloud services and the management software of the SDDCs is carried out through the respective agents of the cloud services.

In one embodiment, a command is issued to a management appliance of an SDDC to modify an inventory of virtual objects deployed in the SDDC. A method of issuing such a command includes the steps of: retrieving a message generated by a cloud service running in a cloud platform, the message including a task to modify the inventory of virtual objects deployed in the SDDC, a first token identifying a user who requested the task, and a second token containing information about the management appliance and a role assigned to the user; exchanging the first and second tokens with the management appliance for an authentication token for accessing the management appliance; and transmitting the command to the management appliance along with the authentication token.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 is a conceptual block diagram of customer environments of different organizations that are managed through a multi-tenant cloud platform.

FIG. 2 illustrates components of the cloud platform and an agent platform appliance with agents through which a command is issued to a management appliance of an SDDC to modify an inventory of virtual objects deployed in the SDDC.

FIG. 3A depicts a sequence of steps carried out to generate an authentication token for accessing the management appliance of the SDDC that is targeted in a command to modify the inventory of virtual objects deployed in the SDDC.

FIG. 3B depicts a sequence of steps carried out to issue the command to the management appliance of the SDDC to modify the inventory of virtual objects deployed in the SDDC, acquire the status of command execution, and report the status of command execution to the cloud platform.

FIG. 4 is a flow diagram that depicts a method of issuing ID and access tokens upon user login.

FIG. 5 is a flow diagram that depicts a method of exchanging an access token that is scoped for all resources of the user's organization to an access token that is scoped for a particular resource of the user's organization.

### DETAILED DESCRIPTION

One or more embodiments enable commands input through a multi-tenant cloud platform to be delivered to a targeted management appliance. A number of different tokens are issued in the process of delivering the commands from the cloud platform to the targeted management appliance. These tokens include ID and access tokens that are generated upon user login, an access token that is scoped for the targeted management appliance, a bearer token that is generated by the targeted management appliance in exchange for the scoped access token, and a holder-of-key token that is generated by the targeted management appliance in exchange for the bearer token. The bearer token allows any holder of the token to access the targeted management appliance but is valid only for a limited period of time after it is issued. The holder-of-key token does not expire but it can be used only by the holder of a key associated with the token.

In the embodiments, an agent of the mutation service (hereinafter referred to as the “mutation agent”) is issued the holder-of-key token, and the mutation agent issues the command to modify the inventory of virtual objects, e.g., a command to create a VM, to the targeted management appliance. In addition, the mutation agent checks on the status of the command execution by periodically polling the targeted management appliance for the status. In both cases, the mutation agent transmits the holder-of-key token to the targeted management appliance to authenticate its access to the targeted management appliance.

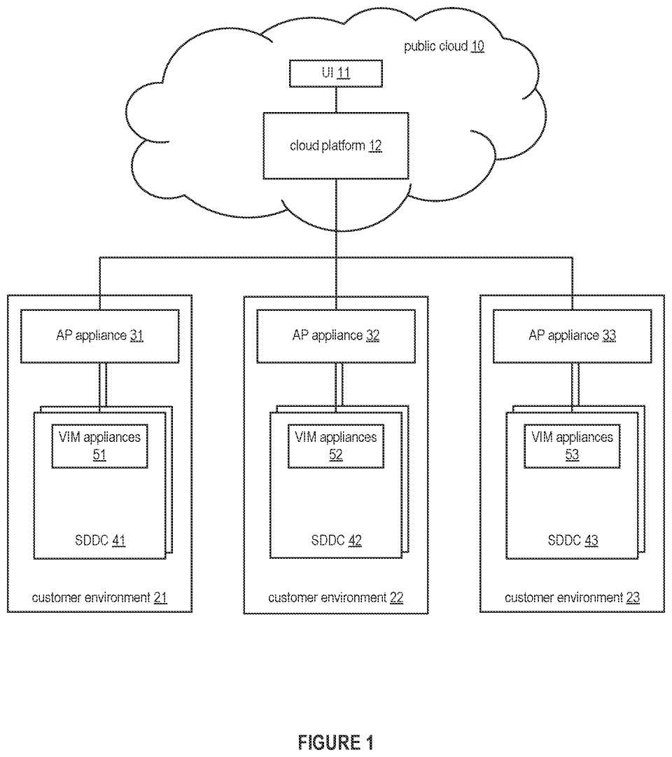

FIG. 1 is a conceptual block diagram of customer environments of different organizations (hereinafter also referred to as “customers” or “tenants”) that are managed through a multi-tenant cloud platform 12, which is implemented in a public cloud 10. A user interface (UI) or an application programming interface (API) that interacts with cloud platform 12 is depicted in FIG. 1 as UI 11.

A plurality of SDDCs is depicted in FIG. 1 in each of customer environment 21, customer environment 22, and customer environment 23. In each customer environment, the SDDCs are managed by respective virtual infrastructure management (VIM) appliances, e.g., VMware vCenter® server appliance and VMware NSX® server appliance. For example, SDDC 41 of the first customer is managed by VIM appliances 51, SDDC 42 of the second customer by VIM appliances 52, and SDDC 43 of the third customer by VIM appliances 53.

The VIM appliances in each customer environment communicate with an agent platform (AP) appliance, which hosts agents (not shown in FIG. 1) that communicate with cloud platform 12, e.g., via a public network, to deliver cloud services to the corresponding customer environment. For example, the VIM appliances for managing the SDDCs in customer environment 21 communicate with AP appliance 31. Similarly, the VIM appliances for managing the SDDCs in customer environment 22 communicate with AP appliance 32, and the VIM appliances for managing the SDDCs in customer environment 23 communicate with AP appliance 33.

As used herein, a “customer environment” means one or more private data centers managed by the customer, which is commonly referred to as “on-prem,” a private cloud managed by the customer, a public cloud managed for the customer by another organization, or any combination of these. In addition, the SDDCs of any one customer may be deployed in a hybrid manner, e.g., on-premise, in a public cloud, or as a service, and across different geographical regions.

In the embodiments, each of the agent platform appliances and the management appliances is a VM instantiated on one or more physical host computers (not shown in FIG. 1) having a conventional hardware platform that includes one or more CPUs, system memory (e.g., static and/or dynamic random access memory), one or more network interface controllers, and a storage interface such as a host bus adapter for connection to a storage area network and/or a local storage device, such as a hard disk drive or a solid state drive. In some embodiments, any of the agent platform appliances and the management appliances may be implemented as a physical host computer having the conventional hardware platform described above.

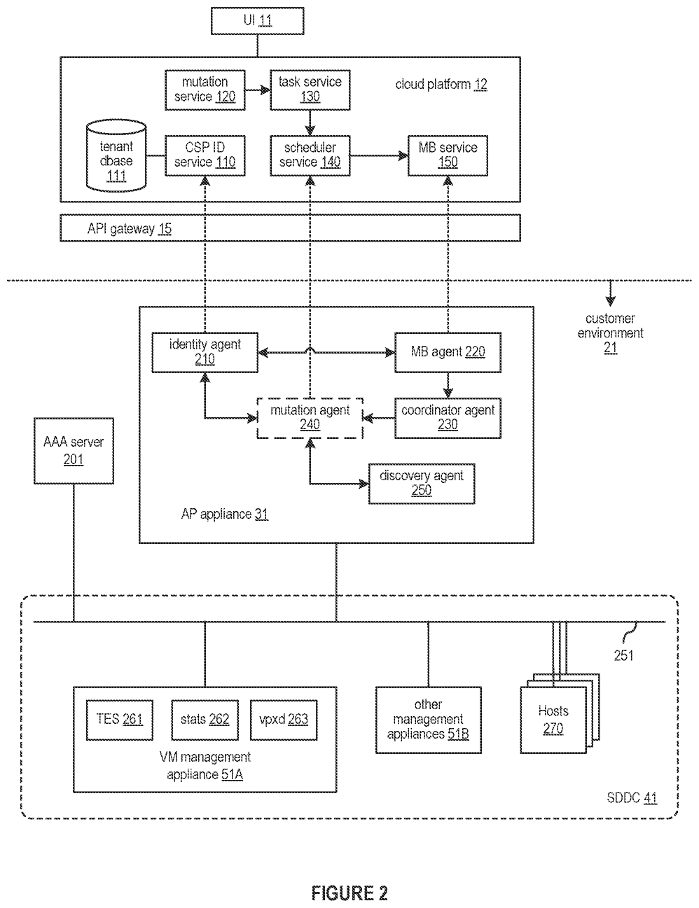

FIG. 2 illustrates components of cloud platform 12 and AP appliance 31 that are used in issuing a command to a management appliance of SDDC 41, e.g., VM management appliance 51A or other management appliance 51B, to modify an inventory of virtual objects deployed in SDDC 41. The command may be any of the following: create or delete a virtual object, such as a VM or virtual disk, and create or delete a tag for associating a plurality of virtual objects to a particular group. In the embodiments described herein, the create VM command is illustrated as an example of the command and the create VM command is issued to VM management appliance 51A, as a result of which a VM is instantiated in one of hosts 270 of a cluster that is managed by VM management appliance 51A via a management network 251 of SDDC 41 that AP appliance 31 is connected to.

The components of cloud platform 12 include a number of different cloud services that enable each of a plurality of tenants that have registered with cloud platform 12 to manage its SDDCs through cloud platform 12. During registration for each tenant, the tenant's profile information, such as the URLs of the management appliances of its SDDCs and the URL of the tenant's AAA (authentication, authorization and accounting) server 201, is collected, and user IDs and passwords for accessing (i.e., logging into) cloud platform 12 through UI 11 are set up for the tenant. The user IDs and passwords are associated with various users of the tenant's organization who are assigned different roles. The tenant profile information is stored in tenant dbase 111, and login credentials for the tenants are managed according to conventional techniques, e.g., Active Directory® or LDAP (Lightweight Directory Access Protocol).

In one embodiment, each of the cloud services is a microservice that is implemented as one or more container images executed on a virtual infrastructure of public cloud 10. The cloud services include a cloud service provider (CSP) ID service 110, a mutation service 120, a task service 130, a scheduler service 140, and a message broker (MB) service 150. Similarly, each of the agents deployed in the AP appliances is a microservice that is implemented as one or more container images executing in the agent platform appliances.

CSP ID service 110 manages authentication of access to cloud platform 12 through UI 11 or through an API call made to one of the cloud services via API gateway 15. Access through UI 11 is authenticated if login credentials entered by the user are valid. API calls made to the cloud services via API gateway 15 are authenticated if they contain CSP access tokens issued by CSP ID service 110. Such CSP access tokens are issued by CSP ID service 110 in response to a request from identity agent 210 if the request contains valid credentials.

Mutation service 120 is the endpoint service of cloud platform 12 to which all commands to modify an inventory of virtual objects deployed in the SDDCs are routed. These commands are hereinafter referred to as “mutation commands.” In response to a mutation command, mutation service 120 creates a task corresponding to the mutation command and makes an API call to task service 130 to perform the task. Task service 130 then schedules the task to be performed with scheduler service 140, which then creates a message containing the task to be performed and inserts the message in a message queue managed by MB service 150. After scheduling the task to be performed with scheduler service 140, task service 130 periodically polls scheduler service 140 for status of the scheduled task.

At predetermined time intervals, MB agent 220, which is deployed in AP appliance 31, makes an API call to MB service 150 to exchange messages that are queued in their respective queues (not shown), i.e., to transmit to MB service 150 messages MB agent 220 has in its queue and to receive from MB service 150 messages MB service 150 has in its queue. Messages from MB service 150 are routed to coordinator agent 230, and if a message contains a task to modify the inventory of virtual objects deployed in SDDC 41, coordinator agent 230 instantiates a mutation agent 240 to manage the performance of the task. Mutation agent 240 thereafter issues a command to a management appliance that is targeted in the task (e.g., by invoking APIs of the management appliance) to perform the task and to check on the status of the task performed by the management appliance. When the task is completed by the management appliance, mutation agent 240 invokes an API of scheduler service 140 to report the completion of the task.

Discovery agent 250 communicates with the management appliances of SDDC 41 to obtain authentication tokens for accessing the management appliances. In the embodiments, mutation agent 240 acquires the authentication token for accessing the management appliance from discovery agent 250 prior to issuing commands to the management appliance, and includes the authentication token in any commands issued to the management appliance.

When the user who input the mutation command inquires about the status of the task corresponding to the mutation command, through UI 11, mutation service 120 invokes an API of task service 130 to check on the status of the task, and task service 130 returns the status of the task to the user through UI 11.

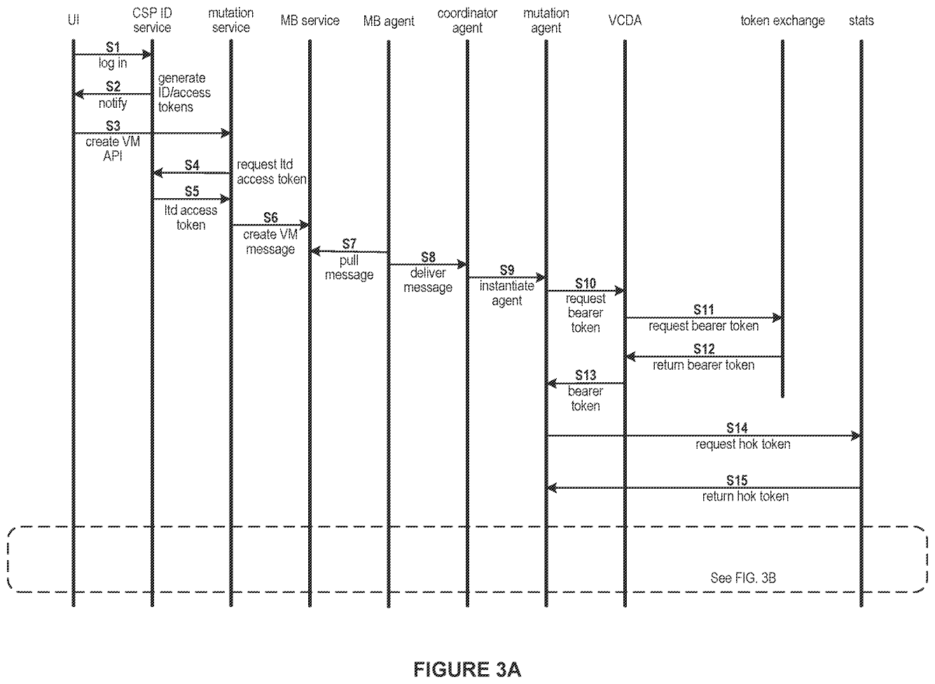

FIG. 3A depicts a sequence of steps carried out to generate an authentication token for accessing the management appliance of the SDDC that is targeted in the mutation command to modify the inventory of virtual objects deployed in the SDDC. In the example illustrated herein, it is assumed that the targeted SDDC is SDDC 41 and so the management appliance of the targeted SDDC is VM management appliance 51A, and the AP appliance of the targeted SDDC is AP appliance 31.

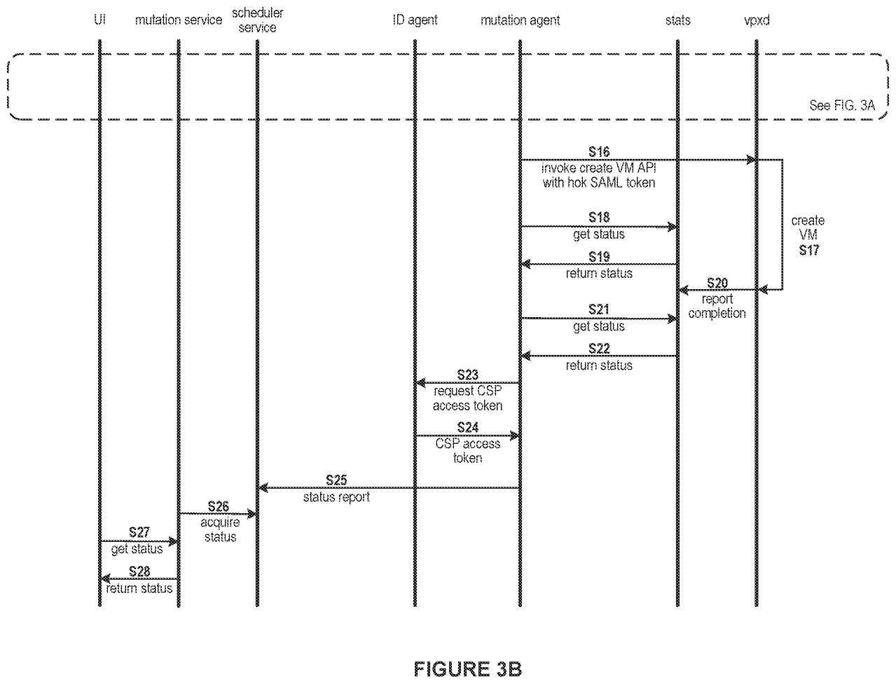

The steps depicted in FIG. 3A begin with the user login process at step S1. In connection with the login process, the user provides login credentials through UI 11. Authentication of the user is handled by CSP ID service 110 as illustrated in FIG. 4.

CSP ID service 110 receives the login credentials of the user at step 408. Then, at step 410, CSP ID service 110 accesses an authentication server of cloud platform 12, e.g., Active Directory® server or LDAP server, to authenticate the user, i.e., that the user provided valid login credentials. If the login credentials are not valid (step 412, No), a login error message is returned to the user through UI 11 at step 414. If the login credentials are valid (step 412, Yes), CSP ID service 110 at step 416 accesses the AAA server of the user's organization to determine the role assigned to the user. At step 418, CSP ID service 110 issues an ID token that identifies the user and an access token for accessing resources of the user's organization, in particular management appliances of the SDDCs of the user's organization. The access token also contains information about the role assigned to the user.

Returning to FIG. 3A, upon user authentication, CSP service 110 generates the ID token and the access token and notifies the user through UI 11 at step S2. After the user has successfully logged in, the user is able to input various commands through UI 11 including a command to modify the inventory of virtual objects deployed in the SDDC of the user's organization. In the example illustrated herein, the command that is input through UI 11 at step S3 is to create a VM, and a create VM API of mutation service 120 is called in response to the input of this command. The create VM API includes the ID and access tokens of the logged-in user and identifies the SDDC in which the user desires to instantiate the VM.

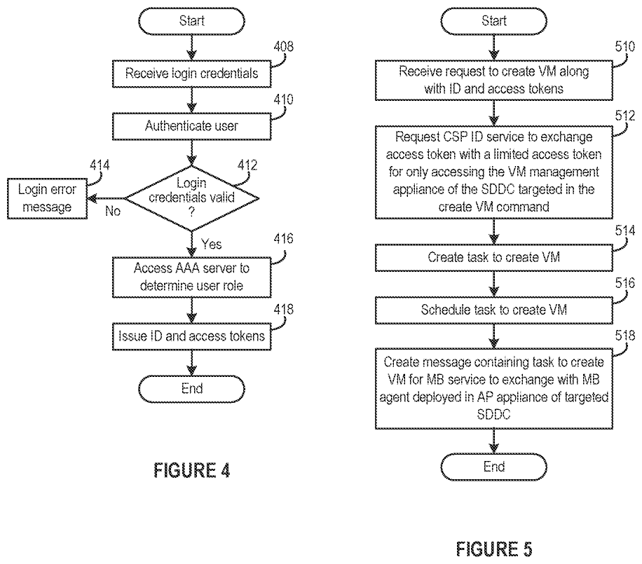

In response to this create VM API, mutation service 120 carries out a method to exchange the access token with a limited access token, as illustrated in FIG. 5. The method begins at step 510 with the receipt of the create VM API. Then, at step 512, mutation service 120 requests CSP ID service 110 to exchange the access token with a limited access token. The limited access token is an access token that limits access to particular resources of the user's organization. In the example illustrated herein, the limited access token limits access to only the VM management appliance of the SDDC in which the user desires to instantiate the VM, i.e., VM management appliance 51A of SDDC 41. After receiving the limited access token from CSP ID service 110, mutation service 120 at step 514 creates a task to create the VM and makes an API call to task service 130 to perform the task. Then, task service 130 at step 516 schedules the task to be performed with scheduler service 140, which at step 518 creates a message containing the task to be performed for MB service 150 to exchange with MB agent 220 deployed in AP appliance 31 of SDDC 41 when MB agent 220 polls MB service 150 for messages.

Returning to FIG. 3A, steps S4 and S5 correspond to step 512 of FIG. 5, and step S6 corresponds to step 518 of FIG. 5. The pulling of the message at step S7 occurs when the message exchange is carried out between MB service 150 and MB agent 220 when MB agent 220 polls MB service 150 for messages.

At step S8, MB agent 220 delivers the message to coordinator agent 230. In the example illustrated herein, because the message contains a task to modify the inventory of virtual objects deployed in the SDDC, i.e., to create a VM, coordinator agent 230 at step S9 instantiates mutation agent 240 to manage the performance of the task.

In the embodiments, access tokens issued by cloud platform 12 provide only discovery agent 250 access to the management appliances of SDDC 41. Any of the other agents may not access the management appliances of SDDC 41 using such access tokens. For any of the other agents to access the management appliances of SDDC 41, the agents must first acquire an authentication token, specifically, a bearer token, issued by the management appliances through discovery agent 250, to be able to access the management appliances. Therefore, prior to issuing commands to management appliance 51A, mutation agent 240 requests discovery agent at step S10 to acquire the bearer token. The request includes the ID and limited access tokens included in the message delivered by MB agent 220 at step S8.

At step S11, discovery agent 250 communicates with a token exchange service (TES) 261 of VM management appliance 51A to acquire a bearer token in exchange for the limited access token. TES 261 first confirms that the limited access token permits access to VM management appliance 51A before issuing the bearer token and returning it to discovery agent 250 at step S12. The bearer token has a time-to-live period that is set upon issuance and is no longer valid upon expiration of the time-to-live period. The bearer token also inherits the role defined in the limited access token. If TES 261 cannot confirm that the limited access token permits access to VM management appliance 51A, the request for the bearer token is denied. Upon receipt of the bearer token from TES 261, discovery agent 250 at step S13 passes the bearer token to mutation agent 240.

At step S14, mutation agent 240 communicates with a stats service 262 of VM management appliance 51A to request that a holder-of-key (hok) token be issued in exchange for the bearer token. The token request includes certificate data of mutation agent 240 and a digital signature that is signed with a private key of mutation agent 240. Prior to issuing the holder-of-key token, stats service 262 first validates the certificate of mutation agent 240 and then validates the digital signature using the public key contained in the certificate. If both validations are successful, the holder-of-key token is issued and returned to mutation agent 240 at step S15. If either validation fails, the request for the holder-of-key token is denied.

Both the bearer token and the holder-of-key token are examples of authentication tokens. Unlike the bearer token, the holder-of-key token does not have a time-to-live period associated therewith and so it does not expire. However, it can only be used by the holder of the key, in this example, mutation agent 240. The holder-of-key token also inherits the role defined in the bearer token.

FIG. 3B depicts a sequence of steps carried out subsequently to the steps depicted in FIG. 3A to issue the command to management appliance 51A to instantiate the VM in SDDC 41, acquire the status of command execution, and report the status of command execution to cloud platform 12. The command is issued by mutation agent 240 at step S16 by calling a create VM API of VM management appliance 51A. The create VM API includes the holder-of-key token, which may be a SAML token, to authenticate access to VM management appliance 51A by mutation agent 240, and invokes a daemon process (vpxd 263) configured in VM management appliance 51A to provision virtual resources such as VMs in hosts 270 of SDDC 41. Accordingly, in response to the create VM API, vpxd 263 initiates the process to instantiate the VM. At the beginning of this process, vpxd 263 accesses AAA server 201 to confirm that the permission to create VMs is assigned to the role defined in the holder-of-key token. If not, vpxd 263 returns an error message to stats service 262. If the permission to create VMs is assigned to the role defined in the holder-of-key token, vpxd 263 executes the process to instantiate the VM at step S17.

After issuing the command to management appliance 51A to instantiate the VM in SDDC 41, mutation agent 240 periodically accesses VM management appliance 51A, e.g., at steps S18 and S21, to get the status of the command execution. Each time mutation agent 240 accesses VM management appliance 51A to get the status of the command execution, mutation agent 240 transmits the holder-of-key token to authenticates its access to VM management appliance 51A. Step S18 represents a status check prior to completion of the command, so the status returned at step S19 is “pending.” When vpxd 263 completes execution of the command, it reports the completion of the command to stats service 262 at step S20. Step S21 represents a status check after completion of the command, so the status returned at step S22 is “completed.”

Upon being notified that the command has completed at step S22, mutation agent 240 acquires a CSP access token through identity agent 210 at steps S23 and S24. This token allows mutation agent 240 to report the status of the task created by mutation service 120 directly to scheduler service 140 without going through the message exchange between MB agent 220 and MB service 150. At step S25, mutation agent 240 calls an API of scheduler service 140 to report the completion status of the task created by mutation service 120.

Step S26 represents mutation service 120 acquiring the task completion status from scheduler service 140 through task service 130. Step S27 represents a periodic polling of UI 11 to obtain the status of the command input at step S3 of FIG. 3A, and step S28 represents the return of the status in response to the periodic polling.

The embodiments described herein may employ various computer-implemented operations involving data stored in computer systems. For example, these operations may require physical manipulation of physical quantities. Usually, though not necessarily, these quantities may take the form of electrical or magnetic signals, where the quantities or representations of the quantities can be stored, transferred, combined, compared, or otherwise manipulated. Such manipulations are often referred to in terms such as producing, identifying, determining, or comparing. Any operations described herein that form part of one or more embodiments may be useful machine operations.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

The embodiments described herein may be practiced with other computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer readable media. The term computer readable medium refers to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Virtualization systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data.

Many variations, additions, and improvements are possible, regardless of the degree of virtualization. The virtualization software can therefore include components of a host, console, or guest OS that perform virtualization functions.

Plural instances may be provided for components, operations, or structures described herein as a single instance. Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of issuing a command to a management appliance of a software-defined data center (SDDC) to modify an inventory of virtual objects deployed in the SDDC, said method comprising:
retrieving a message generated by a cloud service running in a cloud platform, the message including a task to modify the inventory of virtual objects deployed in the SDDC, a first token identifying a user who requested the task, and a second token containing information about the management appliance and a role assigned to the user;
exchanging the first and second tokens with the management appliance for an authentication token for accessing the management appliance; and
transmitting the command to the management appliance along with the authentication token.

2. The method of claim 1, wherein the cloud platform is connected to the SDDC via a public network, and the first and second tokens are generated by the cloud platform.

3. The method of claim 2, wherein the steps of retrieving, exchanging, and transmitting are carried out in an agent platform appliance that is connected to a management network of the SDDC.

4. The method of claim 3, wherein agents of cloud services running in the cloud platform are deployed on the agent platform appliance, and the agents include a first agent that acquires a third token from the management appliance in exchange for the first and second tokens and a second agent that acquires the authentication token from the management appliance in exchange for the third token.

5. The method of claim 4, wherein the third token is a bearer token that has a time-to-live associated therewith and is issued for use by any agent, and the authentication token is a holder-of-key token that does not have a time-to-live associated therewith and is issued to the second agent for use only by the second agent.

6. The method of claim 4, wherein the agents include a third agent for exchanging messages with the cloud platform.

7. The method of claim 1, further comprising:
transmitting a request for a status of the command to the management appliance along with the authentication token; and
upon receipt of notification from the management appliance that the command has completed, transmitting a message to the cloud platform that contains the notification that the command has completed.

8. The method of claim 7, further comprising:
acquiring an access token and transmitting to the cloud platform the access token along with the message that contains the notification that the command has completed.

9. The method of claim 1, wherein the task is to create a virtual machine.

10. A non-transitory computer readable medium comprising instructions to be executed in a computer system to carry out a method of issuing a command to a management appliance of a software-defined data center (SDDC) to modify an inventory of virtual objects deployed in the SDDC, said method comprising:
retrieving a message generated by a cloud service running in a cloud platform, the message including a task to modify the inventory of virtual objects deployed in the SDDC, a first token identifying a user who requested the task, and a second token containing information about the management appliance and a role assigned to the user;
exchanging the first and second tokens with the management appliance for an authentication token for accessing the management appliance; and
transmitting the command to the management appliance along with the authentication token.

11. The non-transitory computer readable medium of claim 10, wherein the cloud platform is connected to the SDDC via a public network, and the first and second tokens are generated by the cloud platform.

12. The non-transitory computer readable medium of claim 11, wherein the steps of retrieving, exchanging, and transmitting are carried out in an agent platform appliance that is connected to a management network of the SDDC.

13. The non-transitory computer readable medium of claim 12, wherein agents of cloud services running in the cloud platform are deployed on the agent platform appliance, and the agents include a first agent that acquires a third token from the management appliance in exchange for the first and second tokens and a second agent that acquires the authentication token from the management appliance in exchange for the third token.

14. The non-transitory computer readable medium of claim 13, wherein the third token is a bearer token that has a time-to-live associated therewith and is issued for use by any agent, and the authentication token is a holder-of-key token that does not have a time-to-live associated therewith and is issued to the second agent for use only by the second agent.

15. The non-transitory computer readable medium of claim 13, wherein the agents include a third agent for exchanging messages with the cloud platform.

16. A computer system comprising an agent platform appliance on which agents of cloud services running in a cloud platform are deployed and a management appliance of a software-defined data center (SDDC) for executing a task to modify an inventory of virtual objects deployed in the SDDC, wherein one of the agents deployed on the agent platform appliance is programmed to carry out the steps of:
retrieving a message generated by one of the cloud services, the message including the task to modify the inventory of virtual objects deployed in the SDDC, a first token identifying a user who requested the task, and a second token containing information about the management appliance and a role assigned to the user;
exchanging the first and second tokens with the management appliance for an authentication token for accessing the management appliance; and
transmitting a command to execute the task, to the management appliance along with the authentication token.

17. The computer system of claim 16, wherein the cloud platform is connected to the SDDC via a public network, and the first and second tokens are generated by the cloud platform.

18. The computer system of claim 17, wherein the agents include a first agent that acquires a third token from the management appliance in exchange for the first and second tokens and a second agent that acquires the authentication token from the management appliance in exchange for the third token.

19. The computer system of claim 18, wherein the third token is a bearer token that has a time-to-live associated therewith and is issued for use by any agent, and the authentication token is a holder-of-key token that does not have a time-to-live associated therewith and is issued to the second agent for use only by the second agent.

20. The computer system of claim 18, wherein the second agent is programmed to carry out the steps of:
transmitting a request for a status of the command to the management appliance along with the authentication token; and
upon receipt of notification from the management appliance that the command has completed, transmitting a message to the cloud platform that contains the notification that the command has completed.
